(19) United States
(12) Patent Application Publication
(10) Pub. No.: US 2020/0000079 A1
(43) Pub. Date: Jan. 2, 2020

(54) INSECT TRAPPER WITH SAFETY PROTECTION DEVICE

(71) Applicant: SHIANN-HSIUNG LIU, Dongguan City (CN)

(72) Inventor: SHIANN-HSIUNG LIU, Dongguan City (CN)

(73) Assignee: Frontier Bio Technology Company Ltd.

(21) Appl. No.: 16/020,949

(22) Filed: Jun. 27, 2018

(51) Int. Cl. A01M 1/10; A01M 1/04

(52) U.S. Cl. CPC A01M 1/106; A01M 2200/012; A01M 1/04

(57) ABSTRACT

An insect trapper with safety protection device comprises a trapper body and a collecting box removably installed in the lower end of trapper body A fan is located in the trapper body. A safety protection device is located between said trapper body and collecting box. The safety protection device has a switch module for controlling automatic startup or automatic stop of fan. When the collecting box is detached from the lower end of trapper body, the switch module is turned off, and the fan stops running to prevent the fan from injuring hand, the use is safe and reliable, and free of locating protecting net in the lower end of trapper body and the protecting net void size, so that the big insects, e.g. moths, can pass through, big and small insects can be trapped simultaneously.

### BACKGROUND OF INVENTION

### 1. Field of the Invention

The present invention relates generally to a technical field of insect trapping, particularly to an insect trapper with safety protection device.

### 2. Description of Related Art

Mosquitoes not only influence people's life, work and rest, but also spread dengue, malaria, yellow fever, filariasis and so on. The conventional mosquito repelling methods include mosquito-repellent incense, floral water, electric mosquito swatter and so on, but the mosquito repelling effect is poor, and the smell generated in the mosquito repelling process harms human health.

The mosquito catcher comprises a mosquito catcher body and a collecting box removably installed on the lower end of mosquito catcher body. A fan is located in the mosquito catcher body. The mosquito catcher body uses light or smell to tempt insects, e.g. mosquitoes. The fan generates airflow to suck the tempted insects, e.g. mosquitoes, into the mosquito catcher body, and into the collecting box, so as to catch mosquitoes.

The domestic and advanced countries' standards have exact rules for motor-driven fan safety. When the collecting box is opened and the collecting box is detached from the mosquito catcher body, the voids of the protecting net located in the lower end of the mosquito catcher body must meet the fan blade probe (e.g. U.S. Standard) and experimental finger (e.g. Chinese Industrial Standards) standards. Generally, when the fan is several centimeters away from the bottom of mosquito catcher body, the standards allowed voids of lower protecting net are too small, many insects cannot pass through the lower protecting net, so that big insects, e.g. moths, block up 4the lower protecting net, influencing the air flow and mosquito catching effect. However, if the voids of lower protecting net are too large, when the collecting box is opened and the collecting box is detached from the mosquito catcher body, the user's fingers may pass through the voids of lower protecting net and reach the fan in the mosquito catcher body and get injured. Therefore, there is safety risk, and it does not meet the test finger test criteria stated in Chinese National Safety Standard GB4706.1-20.2 and American Safety Standard UL507-8.2.6.

### SUMMARY OF THE INVENTION

The purpose of the present invention is to overcome the deficiencies in the existing technology to provide an insect trapper with safety protection device. The technical scheme is to provide an insect trapper with safety protection device comprises a trapper body (1), a collecting box (2) removably installed in a lower end of trapper body (1), a fan (3) disposed in the trapper body (1), and a safety protection device (4) disposed between the trapper body (1) and collecting box (2),

wherein the safety protection device (4) has a switch module for controlling automatic starting or automatic stopping of the fan (3).

More preferably, wherein the collecting box (2) is screwed on the lower end of the trapper body (1), the switch module is turned on, and the fan (3) is actuated automatically; when the collecting box (2) is screwed off the lower end of the trapper body (1), the switch module is turned off, and the fan (3) stops running automatically.

More preferably, wherein the switch module is an inching switch or a photoelectric switch, located in the lower end of the trapper body (1).

More preferably, where in the switch module comprises a reed switch (41) located in the lower end of the trapper body (1) and a first magnet (42) and a second magnet (43) installed in an upper end of collecting box (2).

More preferably, wherein the lower end of trapper body (1) includes a connecting ring (5); the reed switch (41) is fixed to the connecting ring (5), and the connecting ring (5) includes an external thread (51) disposed at a lower end thereof; the collecting box (2) includes an internal thread (21) disposed at an upper thereof; the external thread (51) is fitted with the internal thread (21) so that the connecting ring (5) and collecting box (2) are fixed together.

More preferably, wherein a first and a second support base (52, 53) and a cover plate (54) covering the first and the second support base (52, 53) are formed in the upper end of connecting ring (5); a first and a second support slot (521, 531) are formed respectively in the upper ends of the first and the second support base (52, 53); two ends of said reed switch (41) are placed in the first and the second support slot (521, 531) respectively, and the cover plate (54) is placed on the reed switch (41).

More preferably, wherein a big protecting rack (55) is formed in the connecting ring (5), the big protecting rack (55) is used as lower protecting net.

More preferably, wherein the upper end of collecting box (2) is provided with mounting ring (22); the mounting ring (22) is provided with a first and a second holding groove (221, 222); the first magnet (42) and the second magnet (43) are placed in the first and the second holding groove (221,222) respectively.

More preferably, wherein the upper end of collecting box (2) is provided with an anti-escape funnel (23); the anti-escape funnel (23) covers the mounting ring (22).

More preferably, wherein the trapper body (1) comprises a case (1), an upper protecting net (12) installed at the air inlet in the upper end of case (11) and a top cover (13) located above the upper protecting net (12); the upper protecting net (12) is provided with a bait box (14); the lower end of said top cover (13) is provided with a light trapping device (15).

Compared with the existing technology, the present invention has the following effects. When the collecting box is detached from the lower end of trapper body, the switch module is cut off, the fan stops running automatically to avoid injuring hand, the use is safe and reliable, disregarding the protecting net in the lower end of trapper body and the protecting net void size, so that the big insects, e.g. moths, can pass through, big and small insects can be trapped simultaneously, meeting the test finger test criteria stated in Chinese National Safety Standard GB4706.1-20.2 and American safety standard UL507-8.2.6. When the collecting box is installed on the lower end of trapper body again, the switch module is turned on, the fan is actuated automatically, the insect trapper works, it is easy and convenient to use.

### BRIEF DESCRIPTION OF THE DRAWINGS

FIG. 1 is a perspective view of the present invention;

FIG. 2 is a three-dimensional exploded view of the present invention;

FIG. 3 is an assembly view for the connecting ring and magnetic reed switch of the present invention;

FIG. 4 is a perspective view of collecting box of the present invention;

FIG. 5 is a three-dimensional exploded view of the collecting box of the present invention;

FIG. 6 is an assembly view for connecting ring and the first and the second magnet of the present invention;

FIG. 7 is a sectional view of the present invention;

FIG. 8. is a circuit diagram of the circuit board of the present invention.

### DETAILED DESCRIPTION OF THE INVENTION

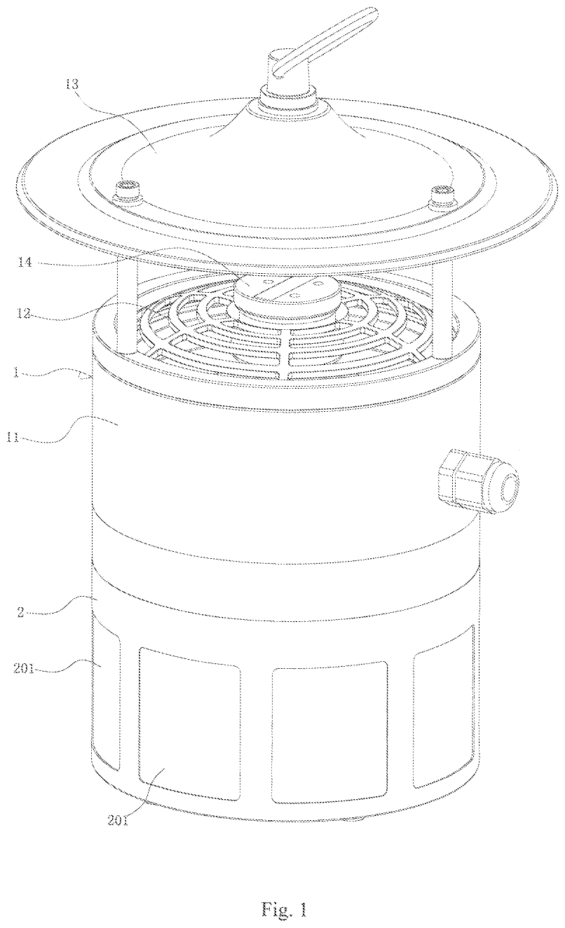

As shown in FIGS. 1-6, the insect trapper with safety protection device of the present invention comprises a trapper body 1 and a collecting box 2 removably installed on the lower end of trapper body 1. A fan 3 and a circuit board 6 are located in the trapper body 1. A safety protection device 4 is located between said trapper body 1 and collecting box 2. The safety protection device 4 contains a switch module for controlling automatic startup or automatic stop of fan 3. The switch module is electrically connected to circuit board 6. The operating principle of said safety protection device 4: when the collecting box 2 is screwed on the lower end of the trapper body 1, the switch module is turned on, the fan 3 is actuated automatically. When the collecting box 2 is screwed off the lower end of the trapper body 1, the switch module is cut off, the fan 3 stops running automatically. Which is to say, when the collecting box 2 is detached from the lower end of trapper body 1, the switch module is disconnected, the fan 3 stop running automatically, preventing the fan 3 from injuring hand, the use is safe and reliable, and free of locating a protecting net in the lower end of trapper body 1 and the protecting net void size, so that the big insects, e.g. moths, can pass through, big and small insects can be trapped simultaneously, meeting Chinese and American safety standards. When the collecting box 2 is installed on the lower end of trapper body 1 again, the switch module is turned on, the fan 3 is actuated automatically, the insect trapper works, it is easy and convenient to use.

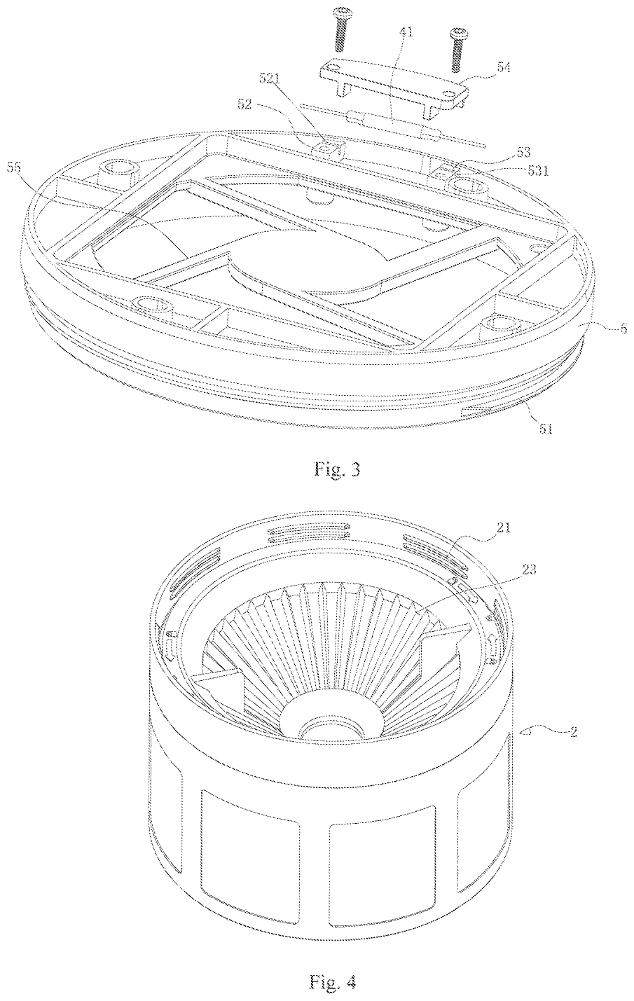

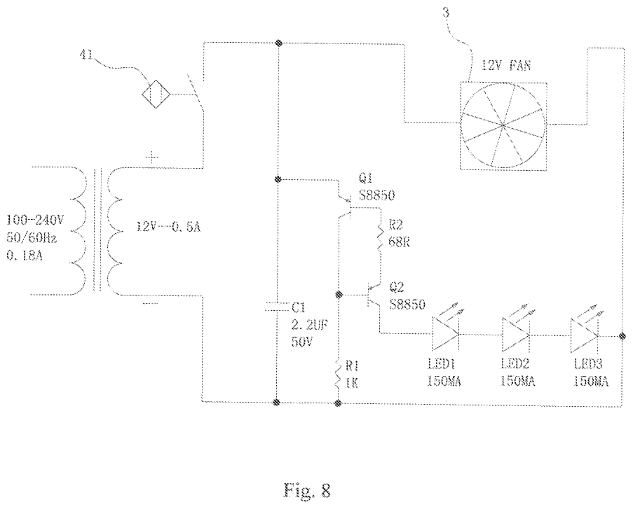

As shown in FIGS. 3, 7 and 8, said switch module comprises a reed switch 41 located in the lower end of said trapper body 1 and the first magnet 42 and the second magnet 43 installed in the upper end of collecting box 2. When the collecting box 2 is installed in the lower end of trapper body 1 again, the first magnet 42 and the second magnet 43 are aligned with both ends of reed switch 41 respectively, magnetizing both ends of the reed switch 41, so that the reed switch 41 is turned on, the fan 3 is actuated automatically, and the insect trapper works. The operating principle of reed switch is conventional technology, which is not detailed herein, please refer to Baidu Baike.

In addition, said switch module can be an inching switch, located in the lower end of said trapper body 1. When the collecting box 2 is installed in the lower end of trapper body 1 again, the inching switch is triggered and turned on, the fan 3 is actuated automatically, and the insect trapper works. Said switch module can be a photoelectric switch. The transmitting end of photoelectric switch is located in the lower end of said trapper body 1. The receiving end of the photoelectric switch is located in the collecting box 2. When the collecting box 2 is installed in the lower end of trapper body 1 again, the transmitting end and receiving end of the photoelectric switch are triggered, the fan 3 is actuated automatically, and the insect trapper works.

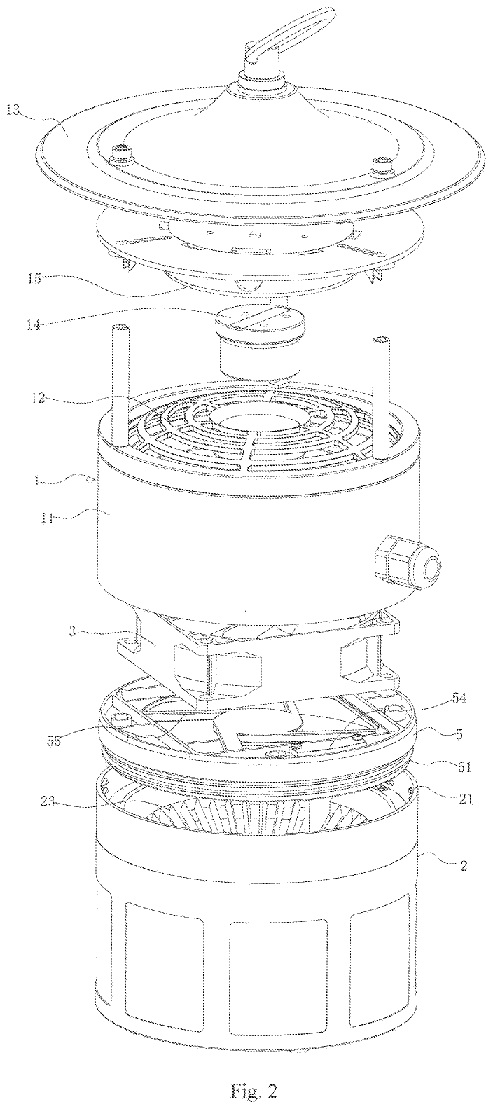

As shown in FIG. 2, the lower end of said trapper body 1 is provided with a connecting ring 5. Said reed switch 41 is fixed to the connecting ring 5, and the lower end of the connecting ring 5 is provided with external thread 51. The upper end of said collecting box 2 is provided with internal thread 21. The external thread 51 and internal thread 21 are fitted to fasten up the connecting ring 5 and collecting box 2. When the external thread 51 and internal thread 21 are screwed up, the first magnet 42 and the second magnet 43 are aligned with both ends of reed switch 41 respectively, see FIG. 7.

Said connecting ring 5 is screwed to the lower end of said trapper body 1.

As shown in FIG. 3, a first and a second support base 52, 53 and a cover plate 54 covering the first and the second support base 52, 53 are formed in the upper end of said connecting ring 5. A first and a second support slot 521, 531 are formed respectively in the upper ends of the first and the second support base 52, 53. Two ends of said reed switch 41 are placed in the first and the second support slot 521, 531, and the cover plate 54 is placed on the top of the reed switch 41, so that the reed switch 41 is installed on connecting ring 5 steadily.

As shown in FIG. 3, a big protecting rack 55 is formed in said connecting ring 5, the big protecting rack 55 is used as lower protecting net, the lower protecting net has large voids, so that the big insects, e.g. moths, can pass through.

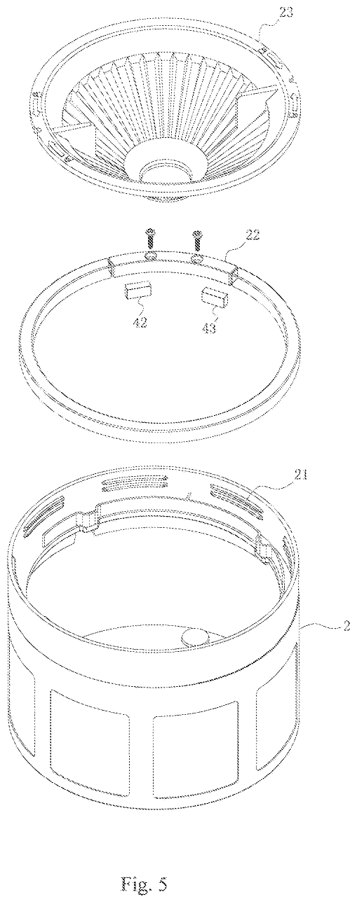

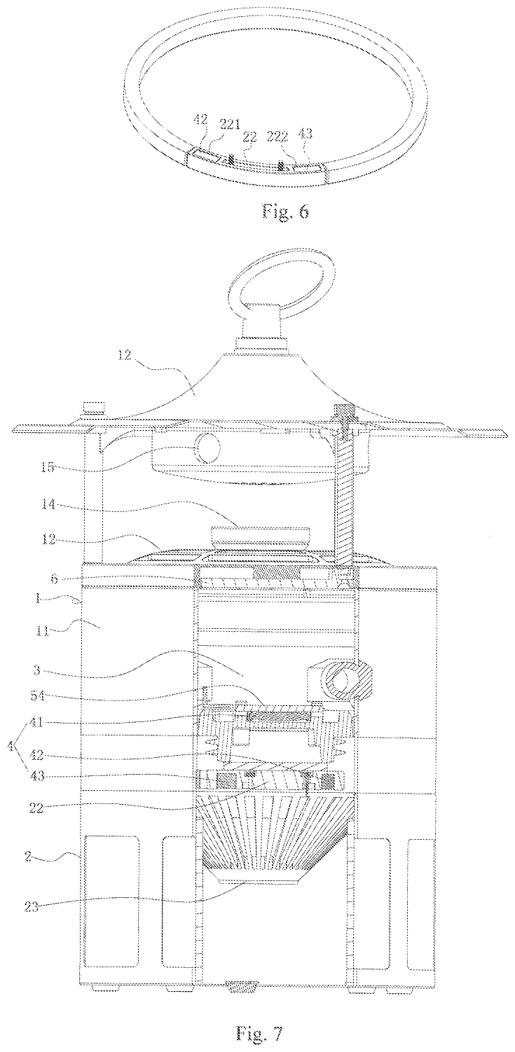

As shown in FIGS. 5 and 6, the upper end of said collecting box 2 is provided with a mounting ring 22. The mounting ring 22 is provided with a first and a second holding groove 221, 222. The first magnet 42 and the second magnet 43 are placed in the first and the second holding groove 221, 222 respectively.

As shown in FIGS. 4 and 5, the upper end of said collecting box 2 is provided with an anti-escape funnel 23. The anti-escape funnel 23 covers the mounting ring 22.

As shown in FIGS. 1, 2 and 7, said trapper body 1 comprises a case 11, an upper protecting net 12 installed at the air inlet in the upper end of case 11 and a top cover 13 located above the upper protecting net 12. The upper protecting net 12 is provided with a bait box 14. The lower end of said top cover 13 is provided with a light trapping device 15. Said fan is installed in the case 11. Said connecting ring 5 is screwed to the lower end of case 11.

Said light trapping device 15 can emit effective spectra to attract insects. The light trapping device 15 contains any one illuminant of LED, fluorescent lamp and cold cathode ray tube. To be specific, said light trapping device 15 comprises a light source box, an aluminum substrate installed in the light source box and a LED installed on aluminum substrate. The aluminum substrate can radiate the heat generated by LED and keep the light source box surface temperature at about 40° C.

The bait in said bait box 14 is any one or the combination of the following items, pheromone, acid containing compound, alcohol containing compound, and compound which can release CO₂ or NH₃ by pyrolysis.

Said insect is mosquito, moth or fruit fly.

Said light trapping device 15 emits mosquito trapping light rays. Said bait box contains volatile bait, a slight amount of CO₂ and bionic smell is emitted through the small holes in the box cover, the mosquitoes with very acute sense of smell can detect the object of attack from a long distance. When the mosquito is attracted by the light rays or smell to the air inlet of trapper body 1, it is sucked in the trapper body 1 with airflow. The fan is fixed in the case. When the fan is actuated, the air flows through the air inlet of case into the case, and then it is led in the collecting box. There are multiple porous nets 201 around the collecting box. When the mosquitoes enter the collecting box with airflow, the air flows out through the meshes, most of insects in the collecting box will die from dehydration.

I claim:

1. An insect trapper with safety protection device comprises a trapper body (1), a collecting box (2) removably installed in a lower end of trapper body (1), a fan (3) disposed in the trapper body (1), and a safety protection device (4) disposed between the trapper body (1) and collecting box (2),
wherein the safety protection device (4) has a switch module for controlling automatic starting or automatic stopping of the fan (3).

2. The insect trapper with safety protection device according to claim 1, wherein the collecting box (2) is screwed on the lower end of the trapper body (1), the switch module is turned on, and the fan (3) is actuated automatically; when the collecting box (2) is screwed off the lower end of the trapper body (1), the switch module is turned off, and the fan (3) stops running automatically.

3. The insect trapper with safety protection device according to claim 1, wherein the switch module is an inching switch or a photoelectric switch, located in the lower end of the trapper body (1).

4. The insect trapper with safety protection device according to claim 1, where in the switch module comprises a reed switch (41) located in the lower end of the trapper body (1) and a first magnet (42) and a second magnet (43) installed in an upper end of collecting box (2).

5. The insect trapper with safety protection device according to claim 4, wherein the lower end of trapper body (1) includes a connecting ring (5); the reed switch (41) is fixed to the connecting ring (5), and the connecting ring (5) includes an external thread (51) disposed at a lower end thereof; the collecting box (2) includes an internal thread (21) disposed at an upper thereof; the external thread (51) is fitted with the internal thread (21) so that the connecting ring (5) and collecting box (2) are fixed together.

6. The insect trapper with safety protection device according to claim 5, wherein a first and a second support base (52, 53) and a cover plate (54) covering the first and the second support base (52, 53) are formed in the upper end of connecting ring (5); a first and a second support slot (521, 531) are formed respectively in the upper ends of the first and the second support base (52, 53); two ends of said reed switch (41) are placed in the first and the second support slot (521, 531) respectively, and the cover plate (54) is placed on the reed switch (41).

7. The insect trapper with safety protection device according to claim 5, wherein a big protecting rack (55) is formed in the connecting ring (5), the big protecting rack (55) is used as lower protecting net.

8. The insect trapper with safety protection device according to claim 4, wherein the upper end of collecting box (2) is provided with mounting ring (22); the mounting ring (22) is provided with a first and a second holding groove (221, 222); the first magnet (42) and the second magnet (43) are placed in the first and the second holding groove (221, 222) respectively.

9. The insect trapper with safety protection device according to claim 8, wherein the upper end of collecting box (2) is provided with an anti-escape funnel (23); the anti-escape funnel (23) covers the mounting ring (22).

10. The insect trapper with safety protection device according to claim 1, wherein the trapper body (1) comprises a case (11), an upper protecting net (12) installed at the air inlet in the upper end of case (11) and a top cover (13) located above the upper protecting net (12); the upper protecting net (12) is provided with a bait box (14); the lower end of said top cover (13) is provided with a light trapping device (15).
